(19) United States
(12) Patent Application Publication
(10) Pub. No.: US 2014/0047793 A1
(43) Pub. Date: Feb. 20, 2014

(54) CONCRETE-MOSAIC

(71) Applicant: LITHOCRETE, INC., Costa Mesa, CA (US)

(72) Inventors: ROBIN BRAILSFORD, DULZURA, CA (US); RONALD D. SHAW, CORONA DEL MAR, CA (US)

(73) Assignee: LITHOCRETE, INC., Costa Mesa, CA (US)

(21) Appl. No.: 14/062,144

(22) Filed: Oct. 24, 2013

Related U.S. Application Data
(63) Continuation of application No. 13/294,434, filed on Nov. 11, 2011.

(51) Int. Cl. B44C 1/28; E04F 13/00

(52) U.S. Cl. CPC B44C 1/28; E04F 13/00
USPC 52/742.14; 52/746.12; 52/747.11

(57) ABSTRACT

Provided is a method of installing a tile mosaic upon a vertical concrete surface. The method includes providing a plurality of tiles, a tile support, and a concrete form. The plurality of tiles are adhered to the tile support to define a mosaic assembly. The tiles are positioned on the tile support corresponding to the mosaic. The mosaic assembly is connected to the concrete form, and concrete is poured within the concrete form such that a portion of the tiles become embedded within the concrete. The tile support is subsequently detached from the concrete form and the concrete form is removed from the cured concrete. The tile support is additionally removed from the plurality of tiles to reveal the mosaic on vertical surface of the concrete structure.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Field of the Invention

The present invention relates in general to concrete products, and more particularly, to methods for creating a mosaic concrete product, specifically, a method of fabricating a module for use in creating a mosaic upon an uncured generally vertical concrete surface and a method of installing the mosaic upon the generally vertical concrete surface utilizing the module.

2. Description of the Related Art

As is well known in the building and construction trade, concrete is extensively utilized as a building material for industrial, commercial and residential applications. Due to its durability, water resistance, and cost economy, concrete has gained wide spread use. With this widespread use, the public is currently demanding variations in color, surface texture and overall appearance of concrete so that the concrete possesses improved aesthetics similar to more conventional and costly surfaces such as stone, mosaic, and terrazzo.

In order to meet this demand, the concrete trade has developed various coloring and surface finishing techniques to enhance the aesthetics of concrete. Examples of such finishing techniques include salt finish, multiple broom finish, form press finish (e.g. stamped concrete), and exposed aggregate finish.

In addition to the extensive use of concrete in building and construction, the use of mosaics in flooring, walls, and other decorative structures and elements has also become significantly widespread. Such products typically include a picture or decorative design. The design is made by completing several steps. First, with regard to flooring, for example, the flooring surface must be prepared, which may include leveling the surface. Secondly, an adhesive, such as mortar or a tile adhesive, is spread upon the surface. After the adhesive is in place, small individual colored mosaic pieces, such as stone or tile, are set into the surface. Once the adhesive is substantially dried, a grouting product is then set between the mosaic pieces to create a uniform surface and further secure the mosaic pieces to the surface. The resultant product is frequently very beautiful and may be very ornate and detailed. However, due to the extensive amount of time and several additional steps that such a product requires in comparison to other flooring products, mosaic flooring are usually quite expensive. Further, construction of mosaics in walls and other decorative structures and elements may also be quite laborious and expensive.

Although concrete and mosaic products have advanced significantly over recent years to meet the demands of customers and innovative builders, there is no current concrete product for use in flooring, walls, or other decorative structures and elements that makes the creation of mosaics more affordable or efficient than the basic process described above.

Therefore, there exists a need in the art for an improved process of creating mosaic products that is more cost and time efficient, particularly for creating a mosaic upon a vertical surface. Various aspects of the present invention are directed toward addresses this particular need, as will be discussed in more detail below.

### BRIEF SUMMARY

According to various aspects of the present invention, there is provided a method of installing a tile mosaic upon a vertical concrete surface. In general, the method includes forming the mosaic on a template and securing the template to a concrete form used to frame the concrete surface. After the concrete has been poured and cured, the form and template may be removed to reveal the mosaic, which is embedded within the cured concrete. The method advantageously provides a quick and easy process by which a template may be formed on a generally vertical concrete surface. Furthermore, it is contemplated that the template may be easily constructed off-site and subsequently transported to the construction site for implementation into the concrete surface. As such, valuable space at the construction site may not be required for construction of the mosaic template.

According to one embodiment, the method includes providing a plurality of tiles, a tile support, and a concrete form. The plurality of tiles are adhered to the tile support to define a mosaic assembly. The tiles are positioned on the tile support corresponding to the mosaic. The mosaic assembly is connected to the concrete form, and concrete is poured within the concrete form such that a portion of the tiles become embedded within the concrete. The tile support is subsequently detached from the concrete form and the concrete form is removed from the cured concrete. The tile support is additionally removed from the plurality of tiles to reveal the mosaic on vertical surface of the concrete structure.

It is contemplated that the concrete form may be stripped or removed while the concrete is in a semi-plastic state. A float may be passed over the tile/concrete surface to create a more uniform surface. Furthermore, a brush, sponge, power washer and/or surface retarder may be used to expose the surface of the concrete.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an upper perspective view of a tile mosaic being installed on a vertical concrete surface;

FIG. 2 is an upper perspective view of a plurality of tiles which collectively define the mosaic, and a mesh tile support for installing the tiles on the concrete surface;

FIG. 3A is a top view of a concrete form defining a pour area, with the tile support and mosaic tiles disposed inside the pour area adjacent the form, the tiles being secured to the tile support via an adhesive;

FIG. 3B is a top view similar to FIG. 3A, with concrete poured into the pour area defined by the concrete form;

FIG. 3C is a top view similar to FIG. 3B with the concrete cured and the form and tile support removed from the cured concrete and mosaic tiles; and

FIG. 3D is a top view similar to FIG. 3C with the adhesive removed from the tiles.

Common reference numerals are used throughout the drawings and detailed description to indicate like elements.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

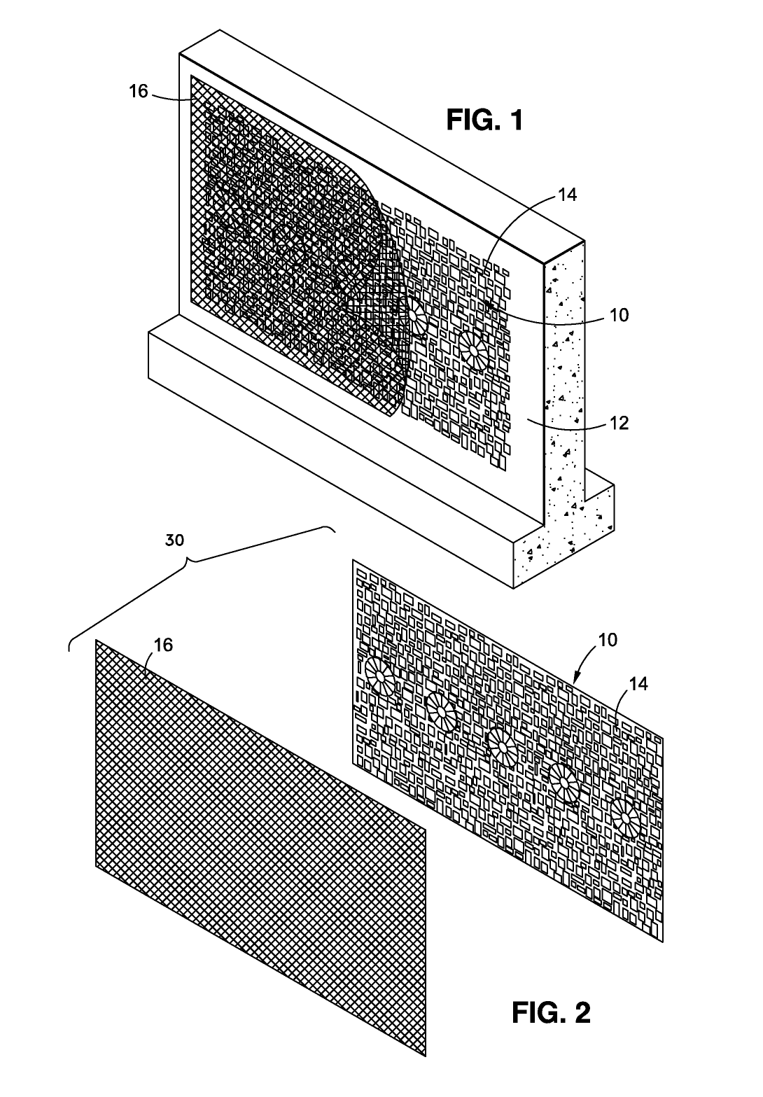

Referring now to the drawings wherein the showings are for purposes of illustrating a preferred embodiment of the invention only, and not for purposes of limiting the same, FIGS. 1-3D show a system and method of creating and installing a mosaic 10 upon a concrete surface 12, particularly a vertical concrete surface 12. The mosaic 10 includes a plurality of tiles 14 which are secured or adhered to a template or tile support 16. The tile support 16 is placed adjacent the concrete form used to define the vertical face of the concrete structure. In a preferred embodiment, the tile support 16 is connected to the concrete form. Concrete is then poured into the form and is allowed to cure. As the concrete cures, the tiles 14 become embedded within the concrete, while a portion of the tile 14 remains exposed. After the concrete has cured, the form is removed from the concrete and the tile support 16 is separated from the tiles 14. The result is a vertical concrete surface having a plurality of tiles embedded therein collectively defining a mosaic 10.

As used herein, the word “vertical” refers to a direction having a directional component aligned with an axis defined by the force of gravity (i.e., the gravitational axis). A vertical face may extend generally upward from a lower support, or generally downward from an upper support. “Vertical” may also indicate a direction that is substantially perpendicular to the horizontal. Along these lines, a vertical surface is not limited to being substantially upright or perpendicular to the horizontal. In this regard, the vertical surface may be slightly offset from the perpendicular to the horizontal.

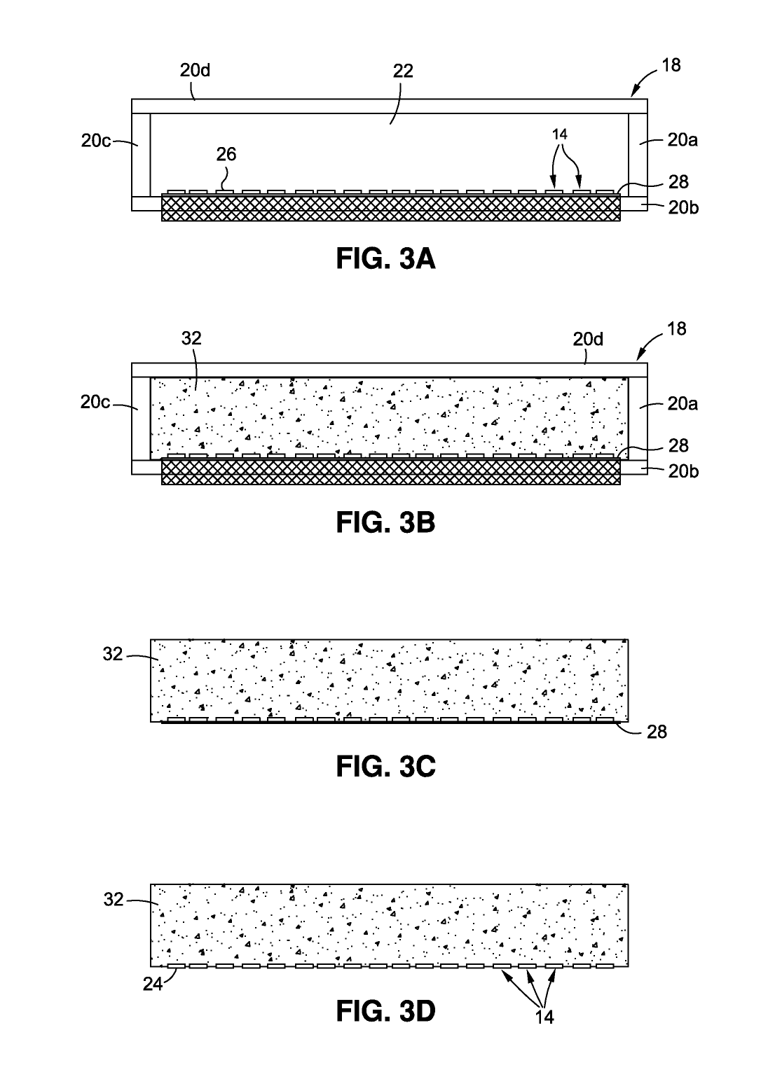

Referring now to FIG. 3A, there is shown a concrete form 18 including form members 20a-20d for constructing a concrete structure, such as a concrete wall similar to the concrete structure shown in FIG. 1. The form members 20a-20d may be formed from wood, plastic, or other materials known in the art. The form 18 is placed upon a base or ground surface, and defines a pour cavity 22 corresponding to the concrete structure. The form 18 shown in FIGS. 3A and 3B includes four form members 20a-20d, which collectively define the pour cavity 22. Each form member 20a-20d defines an inner face and an outer face, with the inner faces of the form members 20a-20d defining the pour cavity 22. Although the form members 20a-20d shown in FIGS. 3A and 3B are planar, it is additionally contemplated that other embodiments may include form members 20a-20d that define other shapes and configurations, such as arcuate or rounded sections. Furthermore, the form 18 shown in FIGS. 3A and 3B defines a pour cavity 22 that is completely circumscribed by the concrete form 18, however, it is understood that the form 18 may only partially circumscribe the cavity 22. For instance, the form 18 may be placed against an existing structure, wherein a portion of the existing structure defines a portion of the cavity 22. The form members 20a-20d defining the form are held together by mechanical fasteners, such as nails or screws, to define the cavity 22 within which the concrete is poured.

The mosaic 10 is comprised of a plurality of tiles 14 which may collectively form an artistic or decorative pattern. The transfer of the tiles 14 to the concrete structure is facilitated by the use of a tile support 16 to which the tiles 14 are preferably temporarily adhered to. The tile support 16 may include a porous material, such as mesh, cloth or paper that is strong enough to support the plurality of tiles 14 included in the mosaic design. As will be described in more detail below, the tiles 14 are adhered to the tile support to 16 maintain the tiles 14 in position while the concrete is poured into the pour cavity 22, as well as maintaining the tiles 14 in position during the curing process.

Referring now to FIGS. 3A and 3D each tile 14 includes an exposed surface 24 (See FIG. 3D) and an embedded surface 26 (See FIG. 3A). The tiles 14 are configured to be placed within the concrete structure such that the embedded surface 26 is embedded within the concrete, while the exposed surface 24 remains exposed to contribute to the overall appearance of the mosaic 10. The tiles 14 may be formed of ceramic, glass, stone, shell, and/or brick tile pieces, and any other variety of ornamental material or combinations thereof. Furthermore, the tiles 14 are preferrably configured to withstand the environmental conditions associated with the location of the concrete structure. For instance, if the concrete structure is located outside, the tiles 14 should be configured to endure extended periods of exposure to the sunlight, as well as temperature changes, precipitation, or other conditions commonly associated with the local environment. A protective coating may be applied to the tiles 14 to provided added protection from the environmental elements.

According to one embodiment, the exposed surfaces 24 of the tiles 14 are temporarily adhered to the tile support 16. When the exposed surfaces 24 of the tiles 14 are adhered to the tiles support 16, the tiles 14 are arranged on the tile support 16 in a “reverse image” configuration, such that when the tiles 14 are placed onto the vertical surface 12, the tiles 14 appear in the correct configuration.

An adhesive 28 may be disposed between the tiles 14 and the tile support 16 to temporarily adhere the tiles 14 to the tile support 16. The adhesive 28 is preferably a water soluble adhesive 28 to facilitate separation of the tile support 16 from the tiles 14 after the concrete cures and the tiles 14 are embedded within the concrete structure.

In one particular implementation, the adhesive 28 is disposed on the tile support 16 prior to placing the tiles 14 on the tile support 16 in the mosaic arrangement. In this regard, it may be easier to apply the adhesive 28 to the tile support 16, rather than applying the adhesive 28 to each tile individually. After the adhesive 28 is completely disposed on the tile support 16, the tiles 14 are then placed on the tile support 16.

According to another implementation, the adhesive 28 is applied to the exposed surface 24 of the tiles 14 before the tiles 14 are placed on the tile support 16. Applying the adhesive 28 to each individual tile 14 may result in a more efficient use of the adhesive 28 (i.e., less adhesive 28 may be used). After the adhesive 28 has been placed on the tiles 14, the tiles 14 may be placed upon the tiles support 16, with the adhesive 28 being disposed between the exposed surface 24 of the tiles 14 and the tile support 16.

The tile support 16 and the tiles 14 placed on the tile support 16 collectively define a mosaic assembly 30 (See FIG. 2). The mosaic assembly 30 is connected to the inner face of the form 18 to dispose the mosaic assembly 30 within the pour cavity 22. The mosaic assembly 30 is arranged with the embedded surfaces 26 of the tiles 14 facing into the cavity 22 and the exposed surfaces 24 of the tiles 14 facing out of the cavity 22 (i.e., toward the adjacent form member). The tile support 16 is disposed between the tiles 14 and the concrete form 18. According to one implementation, the tile support 16 may be secured to the concrete form 18 via mechanical fasteners, such as nails, screws, rivets, staples, adhesives, etc., or may be tied to the form 18, or otherwise secured thereto using techniques known in the art.

The concrete 32 is poured into the pour cavity 22 and is allowed to settle and cure. During the curing process, the mosaic assembly 30 remains adjacent the inner surface of the form 18. It is contemplated that the exposed surface 24 of the tiles 14 may become partially or completely embedded within the concrete 32 when the concrete 32 is poured into the cavity 22. However, as discussed in more detail below, a finishing process may be performed to remove a portion of the concrete 32 and thereby uncover the exposed surfaces 24.

After the concrete 32 has been poured, the form 18 and tile support 16 are removed from the concrete structure and the tiles 14. According to one implementation, the form 18 is removed while the concrete is in a semi-plastic state. The tile support 16 may be configured to peel away from the tiles 14 when the form 18 is removed from the concrete structure. In other words, the tile support 16 and the form 18 may be removed at the same time. In an alternate embodiment, the concrete form 18 and tile support 16 are removed separately. Along these lines, the concrete form 18 is first removed from the concrete structure by separating the tile support 16 from the form 18, and then removing the form 18 from the concrete structure. Subsequently, the tile support 16 may be removed from the tiles 14. To this end, the adhesive 28 binding the tile support 16 to the tiles 14 may be dissolved or otherwise rendered inoperable by spraying water or applying another agent onto the tile support 16. After the adhesive 28 has been dissolved, the tile support 16 may be separated from the tiles 14, leaving the tiles 14 embedded within the concrete 32.

An optional finishing step may be performed to the concrete structure and the tiles 14 after the form 18 has been removed. For instance, a float may be passed over the tiles 14 and concrete before the concrete completely cures to create a more uniform surface. The concrete structure may be sandblasted, acid washed, brushed, sponged, or power washed to remove the top layer of concrete 32, which may further uncover the tiles 14 to more prominently display the mosaic 10, as well as to expose the cement fines to produce a more aesthetic appearance. In addition, a surface retarder may be applied to the form 18 or concrete directly to more prominently display the mosaic 10.

The foregoing describes a method of connecting the tiles 14 to the tile support 16 wherein the exposed surfaces 24 of the tiles 14 are connected to the tile support 16 (referred to as an “outer support” method because the “outer” portion of the tiles 14 are connected to the tile support 16). The following describes an alternative method wherein the embedded surface 26 of the tiles 14 are connected to the tile support 16 (referred to as an “inner support” method because the “inner” portion of the tiles 14 are connected to the tile support 16).

According to the inner support method, the embedded portions 26 of the tiles 14 are coupled to the tile support 16. The tiles 14 may be more permanently adhered to the tile support 16 because the tile support 16 may be embedded within the concrete structure with the tiles 14 in the finished product. In other words, the tile support 16 may not be separated from the tiles 14 after the concrete structure has cured. However, the adhesives 28 described above in relation to the outer support method may also be used for the inner support method.

Given that the embedded portion 26 of the tiles 14 are connected to the tile support 16, the tiles 14 may be placed on the tile support 16 in the configuration which they are to be displayed on the vertical surface 12. In other words, the tiles 14 do not need to be placed in the “reverse” configuration as discussed above in relation to the outer support method. Rather, the tiles 14 can be placed as they will appear in the mosaic 10 on the vertical wall 12.

After the tiles 14 are adhered to the tile support 16 to define the mosaic assembly 30, the mosaic assembly 30 is disposed within the pour cavity 22 adjacent the inner surface of the concrete form 18. The tile support 16 may be attached to the concrete form 18, or to another readily available anchor point. Alternatively, the tile support 16 may have enough rigidity to support itself, i.e., without being anchored to a separate structure. For instance, the tile support 16 may be formed from a wire mesh having an internal rigidity sufficient for supporting the mosaic assembly 30 in an upright, standing configuration.

After the mosaic assembly 30 is disposed within the pour cavity 22, the concrete 32 is poured and is allowed to cure. The mosaic assembly 30 is positioned within the pour cavity 22 such that when the concrete 32 cures, the exposed surfaces 24 of the tiles 14 are exposed and the embedded portions 26 of the tiles 14 are embedded within the concrete 32. After the concrete 32 cures, the concrete form 18 is removed and the finishing steps described above may be performed to the concrete structure.

The above description is given by way of example, and not limitation. Given the above disclosure, one skilled in the art could devise variations that are within the scope of the invention disclosed herein, including various ways of creating different textures, colors, patterns, utilizing various types of mosaic pieces, etc. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of forming a mosaic upon a concrete surface, the method comprising the steps of:
a) providing a plurality of tiles, a tile support, and a concrete form;
b) adhering the plurality of tiles to the tile support to define a mosaic assembly, the tiles being positioned on the tile support corresponding to the mosaic;
c) connecting the mosaic assembly to the concrete form;
d) pouring the concrete within the concrete form such that a portion of the tiles become embedded within the concrete; and
e) removing the concrete form from the concrete.

2. The method as recited in claim 1, wherein the tile support is formed from a porous material.

3. The method as recited in claim 2, wherein the tile support is formed from mesh.

4. The method as recited in claim 1, wherein step b) includes adhering the plurality of tiles to the tile support using a water-soluble adhesive.

5. The method as recited in claim 4, wherein step e) includes spraying water on the tile support to dissolve the adhesive to allow separation of the tile support from the tiles when the concrete form is removed.

6. The method as recited in claim 1, wherein step b) includes applying adhesive to mesh and then placing the plurality of tiles on the mesh to secure the tiles thereto.

7. The method as recited in claim 1, wherein step b) includes applying adhesive to the plurality of tiles and then placing the tiles on the mesh to secure the tiles to the mesh.

8. The method as recited in claim 1, wherein the tile support includes a visual template corresponding to mosaic to facilitate placement of the tiles thereon.

9. The method as recited in claim 1, wherein step c) includes stapling the tile support to the form.

10. The method as recited in claim 1, further comprising the step of sand blasting the cured concrete.

11. The method as recited in claim 1, further comprising the step of acid washing the cured concrete.

12. The method as recited in claim 1, further comprising the step of washing the cured concrete with a surface retarder.

13. The method as recited in claim 1, further comprising the step of sponging the cured concrete.

14. The method as recited in claim 1, further comprising the step of applying a finishing coating to the cured concrete.

15. A method of forming a mosaic upon a concrete surface, the method comprising the steps of:
a) providing a plurality of tiles, a tile support, and a concrete form;
b) adhering the plurality of tiles to the tile support to define a mosaic assembly, the tiles being positioned on the tile support corresponding to the mosaic;
c) disposing mosaic assembly within pour area;
d) pouring the concrete within the concrete form such that a portion of the tiles become embedded within the concrete; and
e) removing the concrete form from the concrete surface.

16. The method as recited in claim 15, wherein the tile support is formed from a porous material.

17. The method as recited in claim 16, wherein the tile support is formed from mesh.

18. The method as recited in claim 15, wherein step b) includes adhering the plurality of tiles to the tile support using a water-soluble adhesive.

19. The method as recited in claim 18, wherein step e) includes spraying water on the tile support to dissolve the adhesive to allow separation of the tile support from the tiles as the concrete form is removed.

20. The method as recited in claim 15, wherein step b) includes applying adhesive to mesh and then placing the plurality of tiles on the mesh to secure the tiles thereto.

21. The method as recited in claim 15, wherein step b) includes applying adhesive to the plurality of tiles and then placing the tiles on the mesh to secure the tiles to the mesh.

22. The method as recited in claim 15, wherein the tile support includes a visual template corresponding to mosaic to facilitate placement of the tiles thereon.

23. A method of forming a mosaic upon a concrete surface, the method comprising the steps of:
a) providing a plurality of tiles, a tile support, and a concrete form;
b) adhering the plurality of tiles to the tile support to define a mosaic assembly, the tiles being positioned on the tile support corresponding to the mosaic;
c) disposing mosaic assembly within pour area;
d) pouring the concrete within the concrete form such that a portion of the tiles become embedded within the concrete;
e) detaching the tile support from the concrete form;
f) removing the concrete form; and
